(19) United States
(12) Patent Application Publication
(10) Pub. No.: US 2025/0182187 A1
(43) Pub. Date: Jun. 5, 2025

(54) METHOD AND APPARATUS FOR PRESENTING INFORMATION, COMPUTER DEVICE, AND STORAGE MEDIUM

(71) Applicant: Beijing Zitiao Network Technology Co., Ltd., Haidian District, Beijing (CN)

(72) Inventor: Jian Wu, Beijing (CN)

(21) Appl. No.: 18/860,810

(22) PCT Filed: Aug. 22, 2023
(86) PCT No.: PCT/CN2023/114290

§ 371 Date: Oct. 28, 2024

(30) Foreign Application Priority Data
Oct. 24, 2022 (CN) 202211300114.9

(51) Int. Cl. G06Q 30/0601; G06F 3/0483; G06F 3/16; G06F 40/279; G10L 13/02

(52) U.S. Cl. CPC G06Q 30/0641; G06F 3/0483; G06F 3/167; G06F 40/279; G10L 13/02

(57) ABSTRACT

The disclosure provides a method and an apparatus for presenting information, a computer device, and a storage medium. The method includes: obtaining a product introduction audio of at least one product associated with a target book, where the product is associated book content of the target book, and the product comprises a physical product and/or a service item; during the playing of audio content of the target book, interluding a product introduction audio of a target product associated with book content that is played; and in response to a target trigger operation, presenting product information of the target product.

### CROSS-REFERENCE

The present application claims priority to Chinese Patent Application No. 202211300114.9, filed on Oct. 24, 2022 and entitled “METHOD AND APPARATUS FOR PRESENTING INFORMATION, COMPUTER DEVICE, AND STORAGE MEDIUM”, which is incorporated herein by reference in its entirety.

### FIELD

The present disclosure relates to the field of computer technologies, and in particular, to a method and an apparatus for presenting information, a computer device, and a storage medium.

### BACKGROUND

When a user reads a book through an e-book reading platform, the user may choose to use a “listen to a book” function. The reading platform enables the user to obtain content recorded in the book by playing the audio of the book. However, information provided to the user by this “listen to a book” function is limited, and can only play the audio of the content recorded in the book itself, and cannot meet the user's need for obtaining peripheral information related to the book.

### SUMMARY

Embodiments of the present disclosure provide at least a method and an apparatus for presenting information, a computer device, and a storage medium.

According to a first aspect, an embodiment of the present disclosure provides a method for presenting information, including: obtaining a product introduction audio of at least one product associated with a target book, where the product is associated with book content of the target book, and the product includes a physical product and/or a service item; during the playing of audio content of the target book, interluding a product introduction audio of a target product associated with book content that is played; and in response to a target trigger operation, presenting product information of the target product.

In an optional implementation, the during the playing of audio content of the target book, interleaving a product introduction audio of a target product associated with book content that is played includes: during the playing of the audio content of the target book, in response to currently played content being a target chapter or a target paragraph in the target book, interluding a product introduction audio corresponding to the target product associated with the target chapter or the target paragraph, where the target chapter and the target paragraph include keyword information associated with the target product.

In an optional implementation, the in response to currently played content being a target chapter or a target paragraph in the target book, interluding a product introduction audio corresponding to the target product associated with the target chapter or the target paragraph includes: in response to currently played content being the target chapter in the target book, after the target chapter is played, and before a next chapter of the target chapter is played, interluding the product introduction audio of the target product associated with the target chapter; or in response to currently played content being the target paragraph in the target book, after the target paragraph is played, and before a next paragraph of the target paragraph is played, interluding the product introduction audio of the target product associated with the target paragraph.

In an optional implementation, the in response to currently played content being a target chapter or a target paragraph in the target book, interluding a product introduction audio corresponding to the target product associated with the target chapter or the target paragraph includes: in response to currently played content being the target chapter in the target book, interluding the product introduction audio of the target product associated with the target chapter based on paragraph position information of an entity keyword associated with the target product in the target chapter; or in response to currently played content being the target paragraph in the target book, interluding the product introduction audio of the target product associated with the target chapter based on sentence position information of the entity keyword associated with the target product in the target paragraph.

In an optional implementation, the product associated with the book content of the target book is determined in the following manner: extracting an entity keyword from the book content of the target book, and determining a plurality of products matching the entity keyword from a predetermined product library; and selecting at least one product from the plurality of products as the product associated with the book content of the target book.

In an optional implementation, the selecting at least one product from the plurality of products includes: determining the at least one product from the plurality of products based on respective consumption conversion rates corresponding to the plurality of products, where a consumption conversion rate corresponding to each product represents a ratio of the product being purchased after being presented; and a consumption conversion rate corresponding to the product is related to at least one of reading popularity corresponding to book content associated with the product, an intrinsic consumption attribute of the product, and a playback environment in which audio content of a target book associated with the product is played.

In an optional implementation, the product introduction audio is obtained in the following manner: determining product information corresponding to the at least one product determined; and performing speech synthesis processing on the product information corresponding to each of the at least one product to obtain the product introduction audio corresponding to the product.

In an optional implementation, the product information of the product includes at least one of the following: description information of the product in the product library and multimedia content information associated with the product, where the multimedia content information is determined based on a multimedia resource associated with a product source to which the product belongs.

In an optional implementation, the performing speech synthesis processing on the product information to obtain the product introduction audio includes: determining a product type corresponding to the product, and determining a product information template corresponding to the product introduction audio of the product type, where the product information template includes a product introduction text corresponding to the product type and at least one reserved fill-in position in the product introduction text to be filled in with the product information; and filling the at least one fill-in position in the product information template with the product information to obtain a filled product information template, and performing speech synthesis processing on the filled product information template to obtain the product introduction audio.

In an optional implementation, the performing speech synthesis processing on the filled product information template to obtain the product introduction audio includes: in response to the audio content of the target book including audio content recorded based on at least one character audio, determining, from the at least one character audio, target character audio used for recording the product introduction audio; and performing audio recording on the filled product information template by using the target character audio to obtain the product introduction audio.

In an optional implementation, after the performing speech synthesis processing on the filled product information template to obtain the product introduction audio, the method further includes: determining a paragraph of the target book to which an entity keyword associated with the target product belongs in the target book, and updating the product introduction audio with audio content corresponding to the paragraph to obtain an updated product introduction audio.

In an optional implementation, the in response to a target trigger operation, presenting product information of the target product includes: in response to the target trigger operation, determining the target product indicated by the target trigger operation, and presenting the product information of the target product in a first region of an audio playback page.

In an optional implementation, the method further includes: determining associated presenting information of the target product, where the associated presenting information includes at least one of an associated product associated with the target product and a sales channel of the target product, the associated product includes a first product other than the target product in a suite product to which the target product belongs, or a second product in a same category as the target product; and presenting the associated presenting information of the target product in a second region associated with the first region.

In an optional implementation, the method further includes: in response to a trigger operation on the associated presenting information, obtaining supplementary presenting information corresponding to the associated presenting information, and presenting the supplementary presenting information, where the supplementary presenting information is used for supplementing and explaining the associated presenting information.

In an optional implementation, in response to the associated presenting information including the first product, the supplementary presenting information corresponding to the associated presenting information includes: multimedia explanation content corresponding to the suite product to which the target product and the first product belong; or in response to the associated presenting information including the second product, the supplementary presenting information corresponding to the associated presenting information includes: multimedia evaluation content corresponding to the target product and/or the second product; or in response to the associated presenting information including the sales channel of the target product, the supplementary presenting information corresponding to the associated presenting information includes at least one of a selling price of the target product in the sales channel and merchant information of a merchant.

According to a second aspect, an embodiment of the present disclosure further provides an apparatus for presenting information, including: an obtaining module, configured to obtain a product introduction audio of at least one product associated with a target book, where the product is associated with book content of the target book, and the product includes a physical product and/or a service item; a playing module, configured to during the playing of audio content of the target book, interluding a product introduction audio of a target product associated with book content that is played; and a presenting module, configured to in response to a target trigger operation, present product information of the target product.

In an optional implementation, when the playing module interludes the product introduction audio of the target product associated with the book content that is played during the playing of the audio content of the target book, the playing module is configured to: during the playing of the audio content of the target book, in response to currently played content being a target chapter or a target paragraph in the target book, interluding a product introduction audio corresponding to a target product associated with the target chapter or the target paragraph, where the target chapter and the target paragraph include keyword information associated with the target product.

In an optional implementation, when the playing module interludes the product introduction audio corresponding to the target product associated with the target chapter or the target paragraph in response to currently played content being the target chapter or the target paragraph in the target book, the playing module is configured to: in response to currently played content being the target chapter in the target book, after the target chapter is played, and before a next chapter of the target chapter is played, interluding the product introduction audio of the target product associated with the target chapter; or in response to currently played content being the target paragraph in the target book, after the target paragraph is played, and before a next paragraph of the target paragraph is played, interluding the product introduction audio of the target product associated with the target paragraph.

In an optional implementation, when the playing module interludes the product introduction audio corresponding to the target product associated with the target chapter or the target paragraph in response to currently played content being the target chapter or the target paragraph in the target book, the playing module is configured to: in response to currently played content being the target chapter in the target book, interluding the product introduction audio of the target product associated with the target chapter based on paragraph position information of an entity keyword associated with the target product in the target chapter; or in response to currently played content being the target paragraph in the target book, interluding the product introduction audio of the target product associated with the target chapter based on sentence position information of the entity keyword associated with the target product in the target paragraph.

In an optional implementation, the obtaining module determines a product associated with the book content of the target book in the following manner: extracting an entity keyword from the book content of the target book, and determining a plurality of products matching the entity keyword from a predetermined product library; and selecting at least one product from the plurality of products as the product associated with the book content of the target book.

In an optional implementation, when the obtaining module selects the at least one product from the plurality of products, the obtaining module is configured to: determine the at least one product from the plurality of products based on respective consumption conversion rates corresponding to the plurality of products, where a consumption conversion rate corresponding to each product represents a ratio of the product being purchased after being presented; and the consumption conversion rate corresponding to the product is related to at least one of reading popularity corresponding to book content associated with the product, an intrinsic consumption attribute of the product, and a playback environment in which audio content of a target book associated with the product is played.

In an optional implementation, the product introduction audio is obtained in the following manner: determining product information corresponding to the at least one product determined; and performing speech synthesis processing on the product information corresponding to each of the at least one product to obtain the product introduction audio corresponding to the product.

In an optional implementation, the product information of the product includes at least one of the following: description information of the product in the product library and multimedia content information associated with the product, where the multimedia content information is determined based on a multimedia resource associated with a product source to which the product belongs.

In an optional implementation, when the obtaining module performs the speech synthesis processing on the product information to obtain the product introduction audio, the obtaining module is configured to: determine a product type corresponding to the product, and determine a product information template corresponding to the product introduction audio of the product type, where the product information template includes a product introduction text corresponding to the product type and at least one reserved fill-in position in the product introduction text to be filled in with the product information; and fill the at least one fill-in position in the product information template with the product information to obtain a filled product information template, and performing speech synthesis processing on the filled product information template to obtain the product introduction audio.

In an optional implementation, when the obtaining module performs the speech synthesis processing on the filled product information template to obtain the product introduction audio, the obtaining module is configured to: in response to the audio content of the target book including audio content recorded based on at least one character audio, determining, from the at least one character audio, target character audio used for recording the product introduction audio; and performing audio recording on the filled product information template by using the target character audio to obtain the product introduction audio.

In an optional implementation, after the obtaining module performs the speech synthesis processing on the filled product information template to obtain the product introduction audio, the obtaining module is further configured to: determine a paragraph of the target book to which an entity keyword associated with the target product belongs in the target book, and update the product introduction audio with audio content corresponding to the paragraph to obtain an updated product introduction audio.

In an optional implementation, when the presenting module presents the product information of the target product in response to the target trigger operation, the presenting module is configured to: in response to the target trigger operation, determine the target product indicated by the target trigger operation, and present the product information of the target product in a first region of an audio playback page.

In an optional implementation, the presenting module is further configured to: determine associated presenting information of the target product, where the associated presenting information includes at least one of an associated product associated with the target product and a sales channel of the target product, the associated product includes a first product other than the target product in a suite product to which the target product belongs, or a second product in a same category as the target product; and present the associated presenting information of the target product in a second region associated with the first region.

In an optional implementation, the presenting module is further configured to: in response to a trigger operation on the associated presenting information, obtaining supplementary presenting information corresponding to the associated presenting information, and presenting the supplementary presenting information, where the supplementary presenting information is used for supplementing and explaining the associated presenting information.

In an optional implementation, in response to the associated presenting information including the first product, the supplementary presenting information corresponding to the associated presenting information includes: multimedia explanation content corresponding to the suite product to which the target product and the first product belong; or in response to the associated presenting information including the second product, the supplementary presenting information corresponding to the associated presenting information includes: multimedia evaluation content corresponding to the target product and/or the second product; or in response to the associated presenting information including the sales channel of the target product, the supplementary presenting information corresponding to the associated presenting information includes at least one of a selling price of the target product in the sales channel and merchant information of a merchant.

According to a third aspect, an optional implementation of the present disclosure further provides a computer device, including a processor and a memory, where the memory stores machine-readable instructions executable by the processor, the processor is configured to execute the machine-readable instructions stored in the memory, and when the machine-readable instructions are executed by the processor, the steps in the above first aspect or any possible implementation of the first aspect are performed.

According to a fourth aspect, an optional implementation of the present disclosure further provides a computer-readable storage medium having stored thereon a computer program that, when executed, performs the steps in the above first aspect or any possible implementation of the first aspect.

According to a method and an apparatus for presenting information, a computer device, and a storage medium provided in the embodiments of the present disclosure, for a target book played in an audio mode, a product introduction audio of at least one associated product can be obtained, and the associated product introduction audio is interluded during the playing of audio content of the target book. In this way, not only the book content included in the book may be transmitted to the user in the audio playback content, but also a product introduction audio of a target product related to the played book content may be provided, and information presented is richer. In addition, in response to a target trigger operation, product information of the target product may be presented, and an audio presenting mode is switched to a presenting mode of text information that can be directly viewed. In this way, when the user has a need, related product information may be presented to the user more intuitively, making it easier for the user to make a further relevant operational decision. Therefore, in the embodiments of the present disclosure, richer related information may be provided to the user when the user reads a book, and convenience in making a relevant operational decision is improved.

To make the above objectives, features, and advantages of the present disclosure more comprehensible, the following preferred embodiments are described in detail below with reference to the accompanying drawings.

### BRIEF DESCRIPTION OF THE DRAWINGS

In order to more clearly illustrate the technical solutions in the embodiments of the present disclosure, the drawings used in the description of the embodiments will be briefly described below. The accompanying drawings in the following description are incorporated into and form a part of the specification, show embodiments consistent with the present disclosure, and are used together with the specification to describe the technical solutions of the present disclosure. It should be understood that the following drawings show only some embodiments of the present disclosure, and therefore should not be considered as a limitation on the scope. Those of ordinary skill in the art may still derive other related drawings from these drawings without creative efforts.

FIG. 1 is a flowchart of a method for presenting information according to an embodiment of the present disclosure;

FIG. 2 is a schematic diagram of an audio playback page according to an embodiment of the present disclosure;

FIG. 3 is a schematic diagram of another audio playback page according to an embodiment of the present disclosure;

FIG. 4 is a schematic diagram of a first page for presenting associated presenting information according to an embodiment of the present disclosure;

FIG. 5 is a schematic diagram of a second page for presenting associated presenting information according to an embodiment of the present disclosure;

FIG. 6 is a schematic diagram of a third page for presenting associated presenting information according to an embodiment of the present disclosure;

FIG. 7 is a schematic diagram of an apparatus for presenting information according to an embodiment of the present disclosure; and

FIG. 8 is a schematic diagram of a computer device according to an embodiment of the present disclosure.

### DETAILED DESCRIPTION

To make the objectives, technical solutions, and advantages of the embodiments of the present disclosure clearer, the technical solutions in the embodiments of the present disclosure will be clearly and completely described below with reference to the accompanying drawings in the embodiments of the present disclosure. It is apparent that the described embodiments are merely some rather than all of the embodiments of the present disclosure. Usually, the components of the embodiments of the present disclosure described and shown herein may be arranged and designed in various different configurations. Therefore, the following detailed description of the embodiments of the present disclosure is not intended to limit the scope of the claimed present disclosure, but is merely representative of selected embodiments of the present disclosure. Based on the embodiments of the present disclosure, all other embodiments obtained by a person of ordinary skill in the art without creative efforts shall fall within the scope of protection of the present disclosure.

It is found through research that the user may select the “listen to a book” function to obtain book information through audio converted from the content recorded in a book. Therefore, when the user uses the “listen to a book” function, the user can only learn the book content included in the book through audio. This manner of transmitting information to the user may allow the user to learn less information, and the content is not rich. Therefore, the user's need for acquiring peripheral information related to the book cannot be met.

Based on the foregoing research, the present disclosure provides a method for presenting information. For a target book played in an audio manner, a product introduction audio of at least one associated product may be obtained, and the associated product introduction audio is interluded during the playing of audio content of the target book. In this way, not only the book content included in the book can be transmitted to the user in the audio playback content, but also the product introduction audio of the target product related to the played book content may be provided, and information presented is richer. In addition, in response to a target trigger operation, product information of the target product may be presented, and an audio presenting mode is switched to a presenting mode of text information that can be directly viewed. In this way, when the user has a need, related product information may be presented to the user more intuitively, making it easier for the user to make a further relevant operational decision. Therefore, in the embodiments of the present disclosure, richer related information may be provided to the user when the user reads a book, and convenience in making a relevant operational decision is improved.

For the problems and the above solutions, all are obtained by the inventors after practice and careful research. Therefore, both the discovery process of the above problems and the solutions proposed by the present disclosure for the above problems in the following text should be contributions made by the inventors to the present disclosure in the process of the present disclosure.

It should be noted that similar reference numerals and letters denote similar items in the following drawings. Therefore, once an item is defined in one drawing, it is not further defined and explained in the subsequent drawings.

To facilitate understanding of this embodiment, a method for presenting information disclosed in the embodiments of the present disclosure is first described in detail. An execution subject of the method for presenting information provided in the embodiments of the present disclosure is generally a computer device with a certain computing capability. The computer device includes, for example, a terminal device, a server, or another processing device. The terminal device may be a user equipment (User Equipment, UE), a mobile device, a user terminal, a terminal, a cellular phone, a cordless phone, a personal digital assistant (Personal Digital Assistant, PDA), a handheld device, a computing device, an in-vehicle device, a wearable device, or the like. In some possible implementations, the method for presenting information may be implemented by a processor invoking a computer-readable instruction stored in a memory.

The method for presenting information provided in the embodiments of the present disclosure is described below by using an example in which an execution subject is a server. The method for presenting information provided in the embodiments of the present disclosure may be, for example, applied to an e-book reading platform. The reading platform described herein may be a web page or an application. After logging in to the e-book reading platform, the user may view and read a book through a plurality of different functions. For example, the user reads the book through a “read” function, that is, directly views book content through a graphical display interface of a user device. Alternatively, the user reads the book through a “listen to a book” function. Specifically, audio information corresponding to the book may be first obtained, for example, text information included in the book is converted into audio information through text-audio conversion, and then the audio information is played for the user, so that the user learns the content included in the book. The following mainly describes the method for presenting information in the scenario of the “listen to a book” function. For details, refer to the following detailed description.

FIG. 1 is a flowchart of a method for presenting information according to an embodiment of the present disclosure. The method includes steps S101 to S103.

S101: Obtain a product introduction audio of at least one product associated with a target book, where the product is associated with book content of the target book, and the product includes a physical product and/or a service item.

S102: During the playing of audio content of the target book, interlude a product introduction audio of a target product associated with book content that is played.

S103: In response to a target trigger operation, present product information of the target product.

The foregoing steps S101 to S103 are described in detail below.

For S101, in the e-book reading platform described above, the target book includes, for example, a book that is selected by the user in the e-book reading platform and that is to be viewed by using the “listen to a book” function. For example, in response to the user selecting the book in the reading platform, a reading page of the book may be presented to the user, and a button for the “listen to a book” function is provided on the reading page. In response to the user triggering the button for the “listen to a book” function corresponding to the book, the book may be used as the target book in the embodiments of the present disclosure. Alternatively, a “listen to a book” column may be set in the e-book reading platform, and a plurality of books for which the “listen to a book” function may be used are included in the “listen to a book” column. In response to the user selecting any book under the “listen to a book” column, the book indicated by the selection operation may be used as the target book in the embodiments of the present disclosure.

To provide more dimensional information to the user during the playing of the audio content of the target book for the user, the product introduction audio of the at least one product associated with the target book may be obtained. In a specific implementation, at least one product associated with the target book may be first determined, and then a corresponding product introduction audio is determined for each product.

First, a specific manner of determining a product associated with book content of the target book is described. In a specific implementation, an entity keyword may be extracted from the book content of the target book, and a plurality of products matching the entity keyword are determined from a predetermined product library; and at least one product is selected from the plurality of products as the product associated with the book content of the target book.

When extracting the entity keyword from the book content of the target book, semantic recognition may be used for the book content. In a possible case, a plurality of entity words may be determined from the book content through semantic recognition, and the entity words are specifically used to indicate an actual object. In addition, a product library may also be predetermined, and a plurality of products and product information related to the products are specifically stored in the product library. The product herein specifically includes a physical product and a service item, for example, a physical product such as cosmetics and food, and a service item such as restaurant consumption and a travel service. Whether there are directly corresponding or associated products in the product library may be determined for the plurality of determined entity words, and if there are, the products may be determined as products matching the entity keywords. Herein, one or more products matching the entity keywords may be determined.

However, during the playing of the audio content of the target book, interluding too much audio related to the product actually interferes with the original playing of the audio content of the target book. To reduce such interference, but still provide the user with audio content of different dimensions, in the embodiments of the present disclosure, a manner of continuing to filter the products from the matched plurality of products is specifically selected to reduce the number of products used for audio playing. Specifically, at least one product may be selected from the plurality of products as the product associated with the book content of the target book. Herein, the number of the at least one product may be determined according to an actual situation, for example, one or two.

In a specific implementation, when the at least one product is selected from the plurality of products, in order to effectively use the played audio information corresponding to the product, thereby reducing the waste of information provided, a product that more likely attracks the attention of the user and is more likely purchased by the user is selected when the product is selected. To quantify the characteristics of the product, in the embodiments of the present disclosure, a manner of determining the at least one product from the plurality of products based on respective consumption conversion rates corresponding to the plurality of products is selected. The consumption conversion rate described herein may express the characteristic of whether the product more likely attracks the attention of the user and is more likely purchased by the user.

A consumption conversion rate corresponding to each product represents a ratio of the product being purchased after being presented. For example, if the plurality of products include certain cosmetics, according to a sales record of the cosmetics, it may be learned that after the cosmetics are introduced to 100 users by playing audio, the sales volume is 60, that is, there were 60 users chose to purchase the cosmetics, and the consumption conversion rate of the cosmetics is 60%, that is, a ratio of the number of purchasing users to the number of presented users. For each product in the determined plurality of products, a corresponding consumption conversion rate may be determined in a similar manner. Each of the plurality of products may be sorted one by one from high to low according to the consumption conversion rate through sorting or the like, and a corresponding number of products are selected from a sorting result from a direction with a highest consumption conversion rate to with a lowest consumption conversion rate according to the determined number of the at least one product, and used as the determined at least one product.

Herein, the consumption conversion rate may actually be related to a plurality of factors. Specifically, a consumption conversion rate corresponding to the product is related to at least one of reading popularity corresponding to book content associated with the product, an intrinsic consumption attribute of the product, and a playback environment in which audio content of a target book associated with the product is played. The following describes the foregoing plurality of different factors and influences of the plurality of different factors on the consumption conversion rate.

(a1) For a case in which a consumption conversion rate corresponding to the product is related to reading popularity corresponding to the book content associated with the product, for example, if a certain paragraph in the book content or the entire book content is with relatively high reading popularity, for example, the certain paragraph is the highlight part of the entire book, more users will focus on the part of the content, or annotate or discuss the part of the content, and the determined product is related to the part of the content. Therefore, it may be considered that the product associated with the part of the content is more likely to be purchased, and the corresponding consumption conversion rate corresponding to the product is higher.

(a2) For a case in which a consumption conversion rate corresponding to the product is related to an intrinsic consumption attribute of the product, for example, if the product itself is a product that is relatively easy to consume or is a currently popular product, the corresponding consumption conversion rate is also relatively higher due to the consumption nature of the product. For example, if the product is an electronic takeaway discount electronic coupon, which is a product general users have a need to purchase, the corresponding consumption conversion rate is relatively high. Alternatively, if a certain smart phone is a relatively popular product in a specific period of time, the smart phone will also have a relatively high consumption conversion rate.

(a3) For a case in which a consumption conversion rate corresponding to the product is related to a playback environment in which the audio content of the target book associated with the product is played, the playback environment is related to, for example, a playback scene, such as an indoor scene or an outdoor scene; or is related to weather during the playback, such as rainy weather, cloudy weather, or sunny weather; or is related to time, such as morning, noon, or night. For the product, the corresponding consumption conversion rate is also affected by these playback environments. For example, for the product umbrella, in a playback environment such as cloudy weather or rainy weather, the product is more likely associated with or more urgently needed in the playback environment. Therefore, the product is more likely to be consumed in these playback environments, that is, the corresponding consumption conversion rate is higher.

The foregoing merely lists and describes several different factors related to the consumption conversion rate, and other factors that may affect the consumption conversion rate are also within the protection scope of the embodiments of the present disclosure, and are not listed one by one herein.

Therefore, for the specific manner of determining the at least one product from the plurality of products through the consumption conversion rate corresponding to the product described above, adjustment may also be made with reference to different influences of the at least three factors on the consumption conversion rate. For example, when a plurality of products are determined for the target book, if a paragraph associated with the product is a paragraph with relatively high reading popularity, or the product itself is a currently popular product, or the product that is more likely to be consumed in the playback environment in which the audio content of the target book is played, it is considered that the corresponding consumption conversion rate is relatively high, and it is appropriate to select the product from the plurality of products as the at least one product.

After the product introduction audio of the at least one product associated with the target book is determined in the foregoing manner, the product introduction audio corresponding to the at least one product may be further obtained. In a specific implementation, the product introduction audio is obtained in the following manner: determining product information corresponding to the at least one product determined; and performing speech synthesis processing on the product information corresponding to each of the at least one product to obtain the product introduction audio corresponding to the product.

For example, for the determined at least one product, a corresponding product introduction audio may be determined for each product. For each product, optionally, the product information corresponding to the product may be first expressed through text information, and then the product introduction audio is obtained through text-to-speech processing, that is, the speech synthesis processing.

The product information corresponding to the product described herein includes at least one of the following: description information of the product in the product library and multimedia content information associated with the product, where the multimedia content information is determined based on a multimedia resource associated with a product source to which the product belongs.

Specifically, in addition to recording the products, the product library also stores the description information of the products in an associated manner. The description information may specifically include a product name, a product effect, and the like of the product. In addition, for a product, there is also associated multimedia content information, such as a test article, an introduction video, an advertisement, a use scenario picture, user evaluation and feedback text, and the like, which may be specifically determined based on a multimedia resource associated with a product source to which the product belongs. For example, if the determined product is a product sold in a store in an e-commerce platform, the store may be used as the product source to which the product belongs, and an introduction video, an advertisement, and the like related to the product in the store are accordingly used as the multimedia content information associated with the product.

Herein, for non-text information included in the product information, for example, text information in a video or picture format, the text information beneficial to the introduction of the product may also be obtained through optical character recognition technology and used as part of the product information of the product.

For the product information, for example, for a determined product “lipstick A”, the determined product information may include the product name “lipstick A”, the current selling price of “200 virtual currency”, the product effect of “enhancing complexion”, and the user evaluation and feedback from 100 users, in which a user is with a relatively high number of likes for the user evaluation and feedback, and the evaluation and feedback text is “the lipstick is easy to use, and can enhance complexion and is not easy to remove”.

The obtained product information may actually be relatively large. For example, for one product, the specifically obtained product information includes two different advertisements, three test contents, and user evaluation and feedback text from 50 users. If all the product information is subjected to speech synthesis processing and played for the user, there may be a problem of an excessively long occupied duration, resulting in an interference with the user's original listening to the audio content of the book. In addition, the obtained product information may be relatively scattered in content. If the information is directly presented to the user, key points cannot be highlighted, resulting in the user failing to obtain effective product information after the information is played for the user. Therefore, after the product information is obtained, in the embodiments of the present disclosure, the product information is not directly converted into speech information for playback, but is integrated to obtain relatively structured information, and then speech synthesis processing is performed on the obtained structured information to obtain the product introduction audio for playing for the user.

In a specific implementation, when the product information is subjected to the speech synthesis processing to obtain the product introduction audio, the following manner may be used: determining a product type corresponding to the product, and determining a product information template corresponding to the product introduction audio of the product type, where the product information template includes a product introduction text corresponding to the product type and at least one reserved fill-in position in the product introduction text to be filled in with the product information; and filling the at least one fill-in position in the product information template with the product information to obtain a filled product information template, and performing the speech synthesis processing on the filled product information template to obtain the product introduction audio.

Specifically, because the products have different product types, different emphases are placed when different products are introduced to the user, and different information integration manners may be selected to structure the product information. Herein, a plurality of possible product types of the product may be predetermined. For example, two product types may be a physical product and a service item included in the product; or a plurality of possible product types may be set in another manner. For each product type, a template of product information corresponding to the product introduction audio of the product type may also be predetermined, to integrate the product information by using the template.

For example, for the foregoing case in which the product type is divided into the physical product, a corresponding product information template of the product type of the physical product may include, for example, “(Product name), the current selling price of the product is (product price), the product (product effect), and there are (the number of users who have provided feedback and evaluation) users who have provided evaluation, and the user evaluation is (user evaluation and feedback)”. Herein, parts in the template that are framed by brackets are the at least one fill-in position, the text in the brackets represents specific content of the filled product information, and parts not framed by brackets are the product introduction text. In addition, some information may be selectively filled. For example, for some products, all the fill-in positions may not be filled in the corresponding product information, and unfilled fill-in positions may be deleted to ensure that the information after speech synthesis is logically coherent and not stuck; or if there are a plurality of pieces of product information that can be filled in one fill-in position, one of them may be selected for filling. For example, evaluation text fed back by different users may be filled in the fill-in position of “user evaluation and feedback”, but specifically, one of the plurality of pieces of user evaluation and feedback may be selected for filling according to a specific rule, for example, the user evaluation and feedback with the highest number of likes is filled, or the latest user evaluation and feedback is filled.

With the example of the product information template, for the lipstick A listed above, the product information template herein may be filled with the product information, and the filled product information template is specifically as follows: “Lipstick A, the current selling price of the product is 200 virtual currency, the product can enhance complexion, and there are 100 users who have provided evaluation, and the user evaluation is that the lipstick is easy to use, and can enhance complexion and is not easy to remove”.

When the filled product information template is obtained, the speech synthesis processing may be performed on the filled product information model to obtain the product introduction audio. In a possible case, a determined artificial intelligence human voice may be selected for simple speech synthesis processing to obtain the product introduction audio.

In another possible case, to better guide the user to listen to the product introduction audio and better transition the original audio content of the target book, when the speech synthesis processing is performed on the filled product information template, audio similar to the audio content of the target book may also be selected for speech synthesis. Specifically, in response to the audio content of the target book including the audio content recorded based on at least one character audio, determining, from the at least one character audio, target character audio used for recording the product introduction audio; and performing audio recording on the filled product information template by using the target character audio to obtain the product introduction audio.

For example, because there is the audio content of the target book, at least one character audio, that is, the character audio for transmitting the audio content to the user, may be determined. Alternatively, for a novel or the like with a plurality of book characters, the audio content of the target book may include a plurality of pieces of different audio content presented by the character audio of the plurality of book characters. Therefore, when the speech synthesis processing is performed on the filled product information template, the target character audio for recording the product introduction audio may be selected from the determined at least one character audio, so that the product introduction audio played for the user is less abrupt in terms of audio timbre, and the listening interest of the user is also easily increased. Specifically, it may be determined whether a part associated with the product in the book content to which the product information belongs involves a certain book character. For example, an entity word corresponding to the product actually appears in dialogue content of a book character A, and the character audio corresponding to the book character A is used as the target character audio for recording the product introduction audio.

In this way, the audio recording is performed on the filled product information template by using the target character audio, to obtain the product introduction audio.

In the foregoing process, the product introduction audio corresponding to each associated product in the target book is determined. Because positions of the products associated in the target book may be relatively scattered, to timely play the product introduction audio when playing to a book position with an associated product during the playing of the audio content of the target book, a manner of determining a paragraph of the target book to which an entity keyword associated with the target product belongs in the target book, and updating the product introduction audio with the audio content corresponding to the paragraph to obtain an updated product introduction audio may be selected. In this way, the corresponding product introduction audio may be directly played after one complete paragraph is played, and the user can also quickly and easily obtain the product associated with the paragraph after listening to one complete paragraph and choose to purchase the product.

For S102, after the product introduction audio of the at least one product is determined according to the foregoing steps, the product introduction audio may be interluded during the playing of the audio content of the target book, so that the user may obtain extended information other than the book content originally included in the target book. Because there may be different associated target products in a plurality of places in the target book, to reflect the association between the book content and the target product to the user during the audio playback, in the embodiments of the present disclosure, an option of interluding a product introduction audio of a target product associated with book content that is played is selected.

Specifically, for a book, the book may specifically include a plurality of chapters, each chapter may include a plurality of paragraphs, each paragraph may include a plurality of sentences, and each sentence is composed of a minimum unit of words. To avoid destroying the structure of the book content, the minimum composition unit may be considered as a sentence. Therefore, in the process of interluding of the product introduction audio, the interluding may be performed after a sentence, a paragraph, or a chapter.

In a specific implementation, in response to currently played content being a target chapter in the target book, after the target chapter is played, and before a next chapter of the target chapter is played, the product introduction audio of the target product associated with the target chapter may be interluded; or in response to currently played content being a target paragraph in the target book, after the target paragraph is played, and before a next paragraph of the target paragraph is played, the product introduction audio of the target product associated with the target paragraph may be interluded. Herein, a chapter or a paragraph is selected as a specific position for interluding.

During specific interluding, if the specific position selected for interluding is a target chapter, specifically, after the target chapter is played, and before the next chapter of the target chapter is played, the product introduction audio of the target product associated with the target chapter may be interluded.

For example, if the target product is associated with a first chapter, the first chapter is used as the target chapter. After the audio content of the target chapter is played, the product introduction audio of the target product is played, and then the next chapter of the target chapter, for example, a second chapter subsequent to the first chapter, is then played.

Alternatively, if the specific position selected for interluding is a target paragraph, specifically, after the target paragraph is played, and before the next paragraph of the target paragraph is played, the product introduction audio of the target product associated with the target paragraph may be interluded.

Similarly, if the target product is associated with a first paragraph under a certain chapter, the first paragraph is used as the target paragraph. After the audio content of the target paragraph is played, the product introduction audio of the target product is played, and then the next paragraph of the target chapter, for example, a second paragraph subsequent to the first paragraph, is then played.

In another possible case, the lengths of the content under chapters and paragraphs in different books are different, for example, for a certain novel, there may be a relatively large number of paragraphs under one chapter, or for a certain film review, there may be a relatively large number of sentences under one paragraph. To play product introduction information closely after an entity keyword associated with a target product to which the product introduction information belongs, even if a part associated with the product is a target chapter or a target paragraph, position information corresponding to a paragraph of the entity keyword in the target chapter or a sentence in the target paragraph may also be selected for interluding.

Specifically, the following manner may be used: in response to currently played content being a target chapter in the target book, interluding the product introduction audio of the target product associated with the target chapter based on paragraph position information of the entity keyword associated with the target product in the target chapter; or in response to currently played content being a target paragraph in the target book, interluding the product introduction audio of the target product associated with the target chapter based on sentence position information of the entity keyword associated with the target product in the target paragraph.

The interluding manner described herein is similar to the interluding manner described above. The described paragraph position information and the sentence position information may specifically be a paragraph end position of a paragraph or a sentence in which the entity keyword is located.

In this way, for the product introduction audio of the target product obtained in the foregoing process, the product introduction audio may be played alternately with the audio content of the target book in an interluded manner, so that the user may obtain more dimensional information related to the book.

For S103, because the playing of the product introduction audio is a one-way manner of transmitting information to the user, the user cannot directly provide feedback on the audio information. However, actually, because the played audio information is the product introduction audio, the user may have a need for viewing the information of the corresponding target product and purchasing. To meet the purchase need of the user, the product information of the target product may be presented in response to a target trigger operation of the user.

Herein, the target trigger operation represents that the user is interested in further viewing a target product corresponding to the product introduction audio. Therefore, the target trigger operation may include, for example, pausing audio playing or a wake-up operation on a graphical display interface. In response to the target trigger operation, the target product indicated by the target trigger operation may be determined, and the product information of the target product is presented in a first region of an audio playback page.

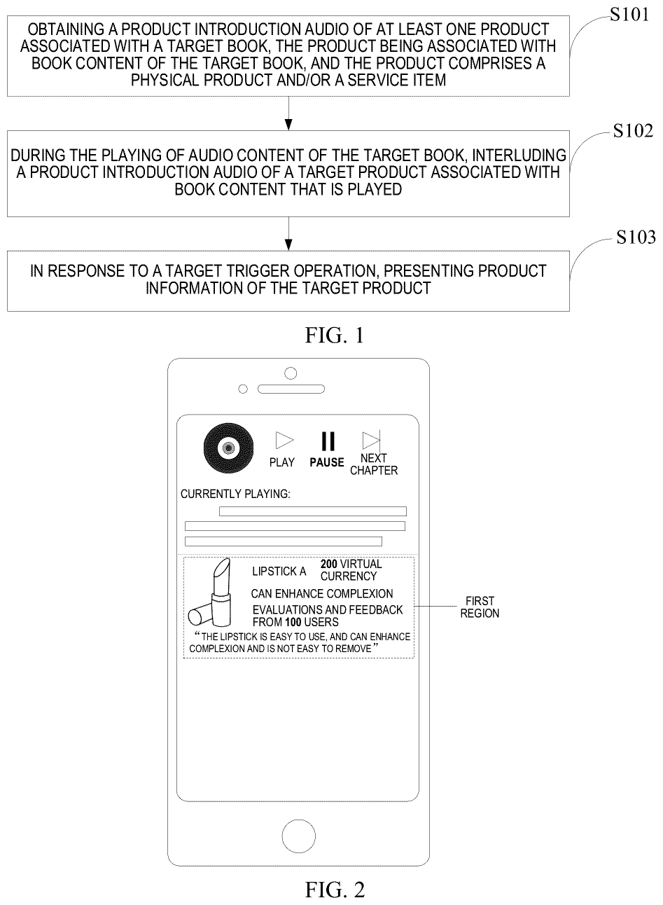

For example, FIG. 2 is a schematic diagram of an audio playback page according to an embodiment of the present disclosure. In the schematic diagram, a record icon in the current “listen to a book” function and basic audio trigger buttons corresponding to play, pause, and play a next chapter are shown, and the current audio playing is paused in bold. The currently played paragraph is also presented below. In addition, the product information of the target product is presented in the first region below, specifically including the product information corresponding to the lipstick A listed in the above example.

In the manner of presenting the product information in the first region, relatively sufficient information of the target product may be presented. However, when the user is interested in the target product, the information that the user hopes to obtain may not be limited to this, and the user may also have a need for obtaining other information related to the target product. Therefore, the associated presenting information associated with the target product may also be determined, and the associated presenting information and the product information of the target product may be presented together.

In a specific implementation, the associated presenting information of the target product may be specifically determined, where the associated presenting information includes at least one of an associated product associated with the target product and a sales channel of the target product, the associated product includes a first product other than the target product in a suite product to which the target product belongs, or a second product in a same category as the target product; and the associated presenting information of the target product is presented in a second region associated with the first region.

For example, for the lipstick A described above, the determined sales channels may include, for example, an e-commerce channel and an offline physical store purchase channel. The associated product may include, for example, another cosmetic in the same series as the lipstick, for example, a cosmetic mirror in the same series, as the first product; or may be a product in the same category, for example, another similar lipstick, as the second product. In addition, viewable links and the like may also be correspondingly provided for these associated presenting information.

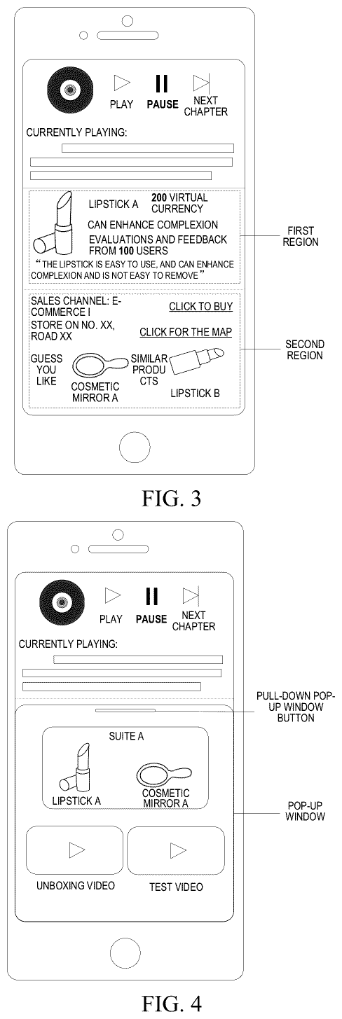

FIG. 3 is a schematic diagram of another audio playback page according to an embodiment of the present disclosure. A second region is presented under the first region of the audio playback page, and includes two different sales channels of the target product. Because the e-commerce channel may be purchased through a link jump, the jump link is specifically presented; and a map function is correspondingly provided under the offline physical store purchase channel to facilitate the user to find a physical store location. In addition, the first product and the second product in the above example are also presented. According to different associations between the first product and the second product and the target product, text identifiers of “guess you like” and “similar products” are indicated for the first product and the second product respectively. In addition, the product name of the product is also presented, and the product name is also the corresponding link to view the product.

In addition, when the associated presenting information is presented in the second region, the second region may actually present relatively limited content. If the user still has a need for further viewing the associated presenting information presented in the second region, information may be supplemented to the associated presenting information, and the supplemented presenting information obtained through supplementation is presented. In a possible case, the supplemented presenting information may be presented through a pop-up window interface, to increase the presenting space for the supplemented presenting information, without blocking the audio playback region. For details, refer to the following description.

Therefore, for the presented associated presenting information, supplementary presenting information corresponding to the associated presenting information may also be obtained and presented in response to a trigger operation on the associated presenting information, where the supplementary presenting information is used to supplement for and explain the associated presenting information.

The following describes the supplementary presenting information related to the foregoing plurality of different associated presenting information:

(b1) For a case in which the associated presenting information includes the first product.

In this case, the supplementary presenting information corresponding to the associated presenting information includes: multimedia explanation content corresponding to a suite product to which the target product and the first product belong.

For the case in which the target product listed in the above example includes lipstick A and the first product includes cosmetic mirror A, the multimedia explanation content corresponding to the suite product includes, for example, an unboxing video or a test video of the suite product shot by an unboxing blogger or a product test blogger, or may also include a test article and the like.

For example, in response to a trigger operation on the first product, for example, a trigger operation on a product picture of the first product in FIG. 3, a page presenting the associated presenting information shown in FIG. 4 may be presented, specifically including a pop-up window, and the associated presenting information is presented on the pop-up window. The associated presenting information specifically includes a suite name, the target product and the first product involved, and may further include the two videos in the above example. In addition, in response to a trigger operation on a video, the video may be presented on the pop-up window or jump to an original web page of the video for presenting.

(b2) For a case in which the associated presenting information includes the second product.

In this case, the supplementary presenting information corresponding to the associated presenting information includes: multimedia test content corresponding to the target product and/or the second product.

Here, because the target product and the second product belong to the same category, the supplementary presenting information that may be presented may specifically include multimedia test content corresponding to each of the two products, or may further include multimedia test content comparing the two products.

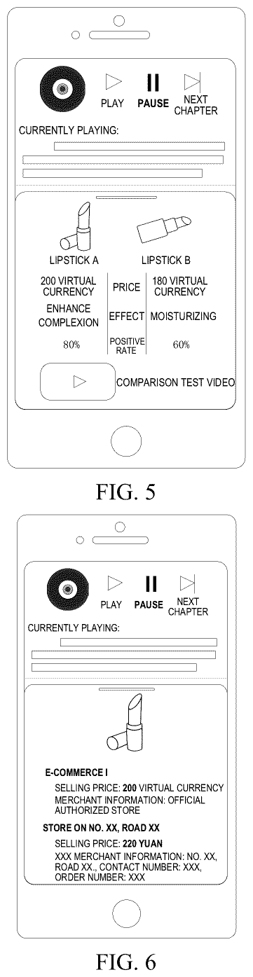

For example, in response to a trigger operation on the second product, for example, a trigger operation on a product picture of the second product in FIG. 3, a page presenting the associated presenting information shown in FIG. 5 may be presented, which may also be specifically in the form of a pop-up window, and the information presented in the pop-up window includes test information corresponding to the target product and the second product respectively, which may specifically be information extracted from multimedia test content corresponding to each of the two products, for example, a comparison of the price and efficacy, and a test video comparing the two products is also presented.

(b3) For a case in which the associated presenting information includes a sales channel of the target product.

In this case, the supplementary presenting information corresponding to the associated presenting information includes at least one of a selling price of the target product in the sales channel and merchant information of a merchant.

Here, when the sales channel is presented, only a plurality of selectable sales channels may be presented, and information of the target product in the sales channel is not presented. Therefore, the supplementary presenting information may be supplemented and presented.

For example, in response to a trigger operation on the sales channel, for example, a trigger operation on the sales channel in FIG. 3, a page presenting the associated presenting information shown in FIG. 6 may be presented. Still taking presenting in the form of a pop-up window as an example, the information presented in the pop-up window includes the selling price in the e-commerce channel and the merchant information of the merchant of the target product and the offline physical store purchase channel in the above example, respectively.

In addition, in the pop-up windows shown in FIGS. 4 to 6, there is also a pull-down pop-up window button. In response to a sliding trigger operation on the pull-down pop-up window button, the pop-up window may be pulled down to the bottom, and the page shown in FIG. 3 is returned accordingly.

In this way, the supplementary presenting information may be flexibly presented through the pop-up window information.

A person skilled in the art may understand that, in the foregoing method of the specific implementation, the sequence of the steps written does not mean a strict execution sequence and does not constitute any limitation on the implementation process. The specific execution sequence of the steps should be determined according to functions and possible internal logic thereof.

Based on the same inventive concept, an apparatus for presenting information corresponding to the method for presenting information is further provided in the embodiments of the present disclosure. Because a principle of the apparatus in the embodiments of the present disclosure for solving the problems is similar to that of the method for presenting information in the embodiments of the present disclosure described above, implementation of the apparatus may refer to implementation of the method, and details that are the same as those in the method will not be repeated.

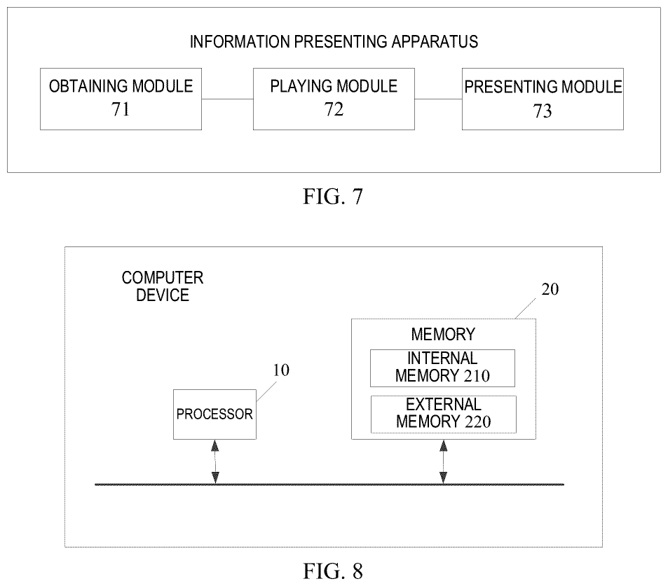

FIG. 7 is a schematic diagram of an apparatus for presenting information according to an embodiment of the present disclosure. The apparatus includes: an obtaining module 71, a playing module 72, and a presenting module 73.

The obtaining module 71 is configured to obtain a product introduction audio of at least one product associated with a target book, where the product is associated with book content of the target book, and the product includes a physical product and/or a service item.

The playing module 72 is configured to during the playing of audio content of the target book, interlude a product introduction audio of a target product associated with book content that is played.

The presenting module 73 is configured to in response to a target trigger operation, present product information of the target product.

In an optional implementation, the playing module 72 is configured to, during the playing of audio content of the target book, interlude a product introduction audio of a target product associated with book content that is played, in the following manner: during the playing of the audio content of the target book, in response to currently played content being a target chapter or a target paragraph in the target book, interluding a product introduction audio corresponding to a target product associated with the target chapter or the target paragraph, where the target chapter and the target paragraph include keyword information associated with the target product.

In an optional implementation, the playing module 72 is configured to, in response to currently played content being the target chapter or the target paragraph in the target book, interluding the product introduction audio corresponding to a target product associated with the target chapter or the target paragraph, in the following manner: in response to currently played content being the target chapter in the target book, after the target chapter is played, and before a next chapter of the target chapter is played, interluding the product introduction audio of the target product associated with the target chapter; or in response to currently played content being the target paragraph in the target book, after the target paragraph is played, and before a next paragraph of the target paragraph is played, interluding the product introduction audio of the target product associated with the target paragraph.

In an optional implementation, the playing module 72 is configured to, in response to currently played content being the target chapter or the target paragraph in the target book, interluding the product introduction audio corresponding to a target product associated with the target chapter or the target paragraph, in the following manner: in response to currently played content being the target chapter in the target book, interluding the product introduction audio of the target product associated with the target chapter based on paragraph position information of an entity keyword associated with the target product in the target chapter; or in response to currently played content being the target paragraph in the target book, interluding the product introduction audio of the target product associated with the target chapter based on sentence position information of the entity keyword associated with the target product in the target paragraph.

In an optional implementation, the obtaining module 71 determines a product associated with book content of the target book in the following manner: extracting an entity keyword from the book content of the target book, and determining a plurality of products matching the entity keyword from a predetermined product library; and selecting at least one product from the plurality of products as the product associated with the book content of the target book.

In an optional implementation, when the obtaining module 71 selects the at least one product from the plurality of products, the obtaining module 71 is configured to: determine the at least one product from the plurality of products based on respective consumption conversion rates corresponding to the plurality of products, where a consumption conversion rate corresponding to each product represents a ratio of the product being purchased after being presented; and the consumption conversion rate corresponding to the product is related to at least one of reading popularity corresponding to book content associated with the product, an intrinsic consumption attribute of the product, and a playback environment in which audio content of a target book associated with the product is played.

In an optional implementation, the product introduction audio is obtained in the following manner: determining product information corresponding to the at least one product determined; and performing speech synthesis processing on the product information corresponding to each of the at least one product to obtain the product introduction audio corresponding to the product.

In an optional implementation, the product information of the product includes at least one of the following: description information of the product in the product library and multimedia content information associated with the product, where the multimedia content information is determined based on a multimedia resource associated with a product source to which the product belongs.

In an optional implementation, when the obtaining module 71 performs the speech synthesis processing on the product information to obtain the product introduction audio, the obtaining module 71 is configured to: determine a product type corresponding to the product, and determine a product information template corresponding to the product introduction audio of the product type, where the product information template includes a product introduction text corresponding to the product type and at least one reserved fill-in position in the product introduction text to be filled in with the product information; and fill the at least one fill-in position in the product information template with the product information to obtain a filled product information template, and performing speech synthesis processing on the filled product information template to obtain the product introduction audio.

In an optional implementation, when the obtaining module 71 performs the speech synthesis processing on the filled product information template to obtain the product introduction audio, the obtaining module 71 is configured to: in response to the audio content of the target book including audio content recorded based on at least one character audio, determining, from the at least one character audio, target character audio used for recording the product introduction audio; and performing audio recording on the filled product information template by using the target character audio to obtain the product introduction audio.

In an optional implementation, after the obtaining module 71 performs the speech synthesis processing on the filled product information template to obtain the product introduction audio, the obtaining module 71 is further configured to: determine a paragraph of the target book to which an entity keyword associated with the target product belongs in the target book, and update the product introduction audio with audio content corresponding to the paragraph to obtain an updated product introduction audio.

In an optional implementation, the presenting module 73 is configured to, in response to a target trigger operation, present product information of the target product, in the following manner: in response to a target trigger operation, determining the target product indicated by the target trigger operation, and presenting the product information of the target product in a first region of an audio playback page.

In an optional implementation, the presenting module 73 is further configured to: determine associated presenting information of the target product, where the associated presenting information includes at least one of an associated product associated with the target product and a sales channel of the target product, the associated product includes a first product other than the target product in a suite product to which the target product belongs, or a second product in a same category as the target product; and present the associated presenting information of the target product in a second region associated with the first region.

In an optional implementation, the presenting module 73 is further configured to: in response to a trigger operation on the associated presenting information, obtain supplementary presenting information corresponding to the associated presenting information, and present the supplementary presenting information, where the supplementary presenting information is used to supplement for and explain the associated presenting information.

In an optional implementation, in response to the associated presenting information including the first product, the supplementary presenting information corresponding to the associated presenting information includes: multimedia explanation content corresponding to a suite product to which the target product and the first product belong; or in response to the associated presenting information including the second product, the supplementary presenting information corresponding to the associated presenting information includes: multimedia test content corresponding to the target product and/or the second product; or in response to the associated presenting information including a sales channel of the target product, the supplementary presenting information corresponding to the associated presenting information includes at least one of a selling price of the target product in the sales channel and merchant information of a merchant.

For descriptions of a processing flow of each module in the apparatus and an interaction flow between the modules, reference may be made to related descriptions in the foregoing method embodiments, and details are not described herein again.

An embodiment of the present disclosure further provides a computer device. As shown in FIG. 8, a schematic diagram of a structure of a computer device according to an embodiment of the present disclosure includes:

a processor 10 and a memory 20, where the memory 20 stores machine-readable instructions executable by the processor 10, and the processor 10 is configured to execute the machine-readable instructions stored in the memory 20. When the machine-readable instructions are executed by the processor 10, the processor 10 executes the following steps:

obtaining a product introduction audio of at least one product associated with a target book, where the product is associated with book content of the target book, and the product includes a physical product and/or a service item; during the playing of audio content of the target book, interluding a product introduction audio of a target product associated with book content that is played; and in response to a target trigger operation, presenting product information of the target product.

The foregoing memory 20 includes an internal memory 210 and an external memory 220. Here, the internal memory 210 is also referred to as an internal storage, and is configured to temporarily store operation data in the processor 10 and data exchanged with an external storage such as a hard disk, and the processor 10 exchanges data with the external memory 220 through the internal memory 210.

For a specific execution process of the foregoing instructions, reference may be made to steps of the method for presenting information described in the foregoing method embodiments, and details are not described herein again.

An embodiment of the present disclosure further provides a computer-readable storage medium. A computer program is stored on the computer-readable storage medium, and when the computer program is run by a processor, the steps of the method for presenting information described in the foregoing method embodiments are executed. The storage medium may be a volatile or non-volatile computer-readable storage medium.

An embodiment of the present disclosure further provides a computer program product. The computer program product carries program code, and instructions included in the program code may be used to execute the steps of the method described for presenting information in the foregoing method embodiments. For details, reference may be made to the foregoing method embodiments, and details are not described herein again.

The computer program product may be specifically implemented through hardware, software, or a combination thereof. In an optional embodiment, the computer program product is specifically embodied as a computer storage medium. In another optional embodiment, the computer program product is specifically embodied as a software product, for example, a software development kit (SDK), and the like.

Persons skilled in the art may clearly understand that for the convenience and brevity of description, for a specific working process of the foregoing described system and apparatus, reference may be made to corresponding processes in the foregoing method embodiments, and details are not described herein again. In several embodiments provided in the present disclosure, it should be understood that the disclosed system, apparatus, and method may be implemented in other manners. The apparatus embodiments described above are merely illustrative. For example, the division of the units is merely a logical function division, and there may be another division manner in actual implementation. For example, a plurality of units or components may be combined or integrated into another system, or some features may be ignored or not performed. In addition, the displayed or discussed mutual couplings or direct couplings or communication connections may be implemented through some communication interfaces. Indirect couplings or communication connections between the apparatuses or units may be implemented in electrical, mechanical, or other forms.

The units described as separate parts may or may not be physically separate, and parts displayed as units may or may not be physical units, and may be located at one position, or may be distributed on a plurality of network units. Some or all of the units may be selected according to actual needs to achieve the objectives of the solutions of the embodiments.

In addition, the functional units in the embodiments of the present disclosure may be integrated into one processing unit, or each of the units may exist alone physically, or two or more units may be integrated into one unit.

If the functions are implemented in the form of a software functional unit and sold or used as an independent product, the functions may be stored in a non-volatile computer-readable storage medium executable by a processor. Based on such an understanding, the technical solutions of the present disclosure are essentially, or the part contributing to the prior art, or part of the technical solutions may be embodied in the form of a software product. The computer software product is stored in a storage medium, and includes several instructions for instructing a computer device (which may be a personal computer, a server, a network device, or the like) to perform all or some of the steps of the methods described in the embodiments of the present disclosure. The foregoing storage medium includes various media capable of storing program code, such as a USB flash drive, a mobile hard disk, a read-only memory (ROM), a random access memory (RAM), a magnetic disk, or an optical disc.

Finally, it should be noted that the foregoing embodiments are merely specific implementations of the present disclosure, and are used to describe the technical solutions of the present disclosure, but not to limit the present disclosure. The scope of protection of the present disclosure is not limited thereto. Although the present disclosure is described in detail with reference to the foregoing embodiments, persons of ordinary skill in the art should understand that any person skilled in the art can still modify the technical solutions described in the foregoing embodiments or can easily conceive of changes to the technical solutions, or make equivalent replacements to some technical features; however, these modifications, changes, or replacements do not cause the essence of the corresponding technical solutions to depart from the spirit and scope of the technical solutions of the embodiments of the present disclosure, and all should fall within the scope of protection of the present disclosure. Therefore, the scope of protection of the present disclosure shall be subject to the scope of protection of the claims.

1. A method for presenting information, comprising:
obtaining a product introduction audio of at least one product associated with a target book, the product being associated with book content of the target book, and the product comprising a physical product and/or a service item;
during playing of audio content of the target book, interluding a product introduction audio of a target product associated with book content that is played;
in response to a target trigger operation, presenting product information of the target product.

2. The method according to claim 1, wherein the during playing of audio content of the target book, interluding a product introduction audio of a target product associated with book content that is played comprises:
during the playing of the audio content of the target book, in response to currently played content being a target chapter or a target paragraph in the target book, interluding a product introduction audio corresponding to a target product associated with the target chapter or the target paragraph, wherein the target chapter and the target paragraph comprise keyword information associated with the target product.

3. The method according to claim 2, wherein the in response to currently played content being a target chapter or a target paragraph in the target book, interluding a product introduction audio corresponding to a target product associated with the target chapter or the target paragraph comprises:
in response to currently played content being a target chapter in the target book, after the target chapter is played, and before a next chapter of the target chapter is played, interluding the product introduction audio of the target product associated with the target chapter; or
in response to currently played content being the target paragraph in the target book, after the target paragraph is played, and before a next paragraph of the target paragraph is played, interluding the product introduction audio of the target product associated with the target paragraph.

4. The method according to claim 2, wherein the in response to currently played content being a target chapter or a target paragraph in the target book, interluding a product introduction audio corresponding to a target product associated with the target chapter or the target paragraph comprises:
in response to currently played content being the target chapter in the target book, interluding the product introduction audio of the target product associated with the target chapter based on paragraph position information of an entity keyword associated with the target product in the target chapter; or
in response to currently played content being the target paragraph in the target book, interluding the product introduction audio of the target product associated with the target chapter based on sentence position information of the entity keyword associated with the target product in the target paragraph.

5. The method according to claim 1, wherein the product associated with book content of the target book is determined by:
extracting an entity keyword from the book content of the target book, and determining a plurality of products matching the entity keyword from a predetermined product library;
selecting at least one product from the plurality of products as the product associated with the book content of the target book.

6. The method according to claim 5, wherein the selecting at least one product from the plurality of products comprises:
determining the at least one product from the plurality of products based on respective consumption conversion rates corresponding to the plurality of products, wherein a consumption conversion rate corresponding to each product represents a ratio of the product being purchased after being presented;
wherein the consumption conversion rate corresponding to the product is related to at least one of reading popularity corresponding to book content associated with the product, an intrinsic consumption attribute of the product, and a playback environment in which audio content of a target book associated with the product is played.

7. The method according to claim 1, wherein the product introduction audio is obtained by:
determining product information corresponding to the determined at least one product; and
performing speech synthesis processing on the product information corresponding to each of the at least one product, to obtain the product introduction audio corresponding to the product.

8. The method according to claim 7, wherein the product information of the product comprises at least one of the following:
description information of the product in the product library, or multimedia content information associated with the product, wherein the multimedia content information is determined based on a multimedia resource associated with a product source to which the product belongs.

9. The method according to claim 7, wherein the performing speech synthesis processing on the product information to obtain the product introduction audio comprises:
determining a product type corresponding to the product, and determining a product information template corresponding to the product introduction audio of the product type, wherein the product information template comprises a product introduction text corresponding to the product type and at least one reserved fill-in position in the product introduction text to be filled in with the product information; and
filling the at least one fill-in position in the product information template with the product information, to obtain a filled product information template, and performing the speech synthesis processing on the filled product information template to obtain the product introduction audio.

10. The method according to claim 9, wherein the performing speech synthesis processing on the filled product information template to obtain the product introduction audio comprises:
in response to the audio content of the target book including audio content recorded based on at least one character audio, determining, from the at least one character audio, target character audio used for recording the product introduction audio; and
performing audio recording on the filled product information template by using the target character audio, to obtain the product introduction audio.

11. The method according to claim 9, wherein after the performing speech synthesis processing on the filled product information template to obtain the product introduction audio, the method further comprises:
determining a paragraph of the target book to which an entity keyword associated with the target product belongs, and updating the product introduction audio with audio content corresponding to the paragraph, to obtain an updated product introduction audio.

12. The method according to claim 1, wherein in the in response to a target trigger operation, presenting product information of the target product comprises:
in response to the target trigger operation, determining the target product indicated by the target trigger operation, and presenting the product information of the target product in a first region of an audio playback page.

13. The method according to claim 12, further comprising:
determining associated presenting information of the target product, the associated presenting information including at least one of an associated product associated with the target product and a sales channel of the target product, the associated product includes a first product other than the target product in a suite product to which the target product belongs or a second product in a same category as the target product; and
presenting the associated presenting information of the target product in a second region associated with the first region.

14. The method according to claim 13, further comprising:
in response to a trigger operation on the associated presenting information, obtaining supplementary presenting information corresponding to the associated presenting information, and presenting the supplementary presenting information, the supplementary presenting information being configured to supplement for and explain the associated presenting information.

15. The method according to claim 13, wherein in that in response to the associated presenting information including the first product, the supplementary presenting information corresponding to the associated presenting information includes: multimedia explanation content corresponding to the suite product to which the target product and the first product belong; or
in response to the associated presenting information including the second product, the supplementary presenting information corresponding to the associated presenting information includes: multimedia evaluation content corresponding to the target product and/or the second product; or
in response to the associated presenting information including a sales channel of the target product, the supplementary presenting information corresponding to the associated presenting information includes at least one of a selling price of the target product in the sales channel and merchant information of a merchant.

16. (canceled)

17. A computer device, comprising: a processor and a memory storing machine-readable instructions executable by the processor, the processor being configured to execute the machine-readable instructions stored in the memory, and when the machine-readable instructions are executed by the processor, the processor performs a method for presenting information, comprising:
obtaining a product introduction audio of at least one product associated with a target book, the product being associated with book content of the target book, and the product comprising a physical product and/or a service item;
during playing of audio content of the target book, interluding a product introduction audio of a target product associated with book content that is played;
in response to a target trigger operation, presenting product information of the target product.

18. (canceled)

19. The computer device according to claim 17, wherein the during playing of audio content of the target book, interluding a product introduction audio of a target product associated with book content that is played comprises:
during the playing of the audio content of the target book, in response to currently played content being a target chapter or a target paragraph in the target book, interluding a product introduction audio corresponding to a target product associated with the target chapter or the target paragraph, wherein the target chapter and the target paragraph comprise keyword information associated with the target product.

20. The computer device according to claim 17, wherein the product associated with book content of the target book is determined by:
extracting an entity keyword from the book content of the target book, and determining a plurality of products matching the entity keyword from a predetermined product library;
selecting at least one product from the plurality of products as the product associated with the book content of the target book.

21. The computer device according to claim 17, wherein the product introduction audio is obtained by:
determining product information corresponding to the determined at least one product; and
performing speech synthesis processing on the product information corresponding to each of the at least one product, to obtain the product introduction audio corresponding to the product.

22. A non-transitory computer-readable storage medium, wherein a computer program is stored on the computer-readable storage medium, and when the computer program is run by a computer device, the computer device performs a method for presenting information, comprising:
obtaining a product introduction audio of at least one product associated with a target book, the product being associated with book content of the target book, and the product comprising a physical product and/or a service item;
during playing of audio content of the target book, interluding a product introduction audio of a target product associated with book content that is played;
in response to a target trigger operation, presenting product information of the target product.
